(19) United States
(12) Patent Application Publication
(10) Pub. No.: US 2001/0056361 A1
(43) Pub. Date: Dec. 27, 2001

(54) Car rental system

(76) Inventor: Mitsuru Sendouda, Tokyo (JP)

Correspondence Address: ROSENMAN & COLIN LLP, 575 MADISON AVENUE, NEW YORK, NY, 10022-2585, US

(21) Appl. No.: 09/878,052

(22) Filed: Jun. 8, 2001

(30) Foreign Application Priority Data
Jun. 21, 2000 (JP) 2000-186001

(51) Int. Cl. G06F 17/60

(52) U.S. Cl. 705/5

(57) ABSTRACT

A car rental system receives a rental order specifying the model of a rental car and a delivery location at which the user wishes the rental car to be delivered. The car rental agency delivers the specified rental car to the specified location, and leaves the rental car without attending to the user. The user goes to the specified location and then drives the rental car by using a password and a card key previously delivered to the user.

### BACKGROUND OF THE INVENTION

1. Field of the Invention

The present invention relates to a car rental system for smoothly performing renting cars by using a network.

2. Description of the Related Art

It takes a lot of cost to own and maintain a motorcar (car) in a metropolitan area. For example, it is difficult and expensive to keep a parking spot in such an area. Under such circumstances, the cost for maintaining a car is unjustifiable with respect to the amount of time the car is used. In view of this, where the amount of time one needs to use a car is limited, it is cost-effective to rent a car when necessary rather than to own a car. However, a disadvantage of renting a car is that the user has to go to a car rental agency and go through a tiresome procedure. Thus, renting a car has not been as convenient as using one's own car. It is troublesome to go to the car rental agency especially when it is raining, which has been discouraging the use of a rental car.

The Internet is sometimes used to check which cars are available and to make a reservation when a specifically desired car is available. This can simplify the car-renting procedure and facilitate the use of a rental car.

In such a car rental system, in which the conventional renting procedure is simplified, it is still common that the user has to go to the car rental agency. In order to further facilitate the car renting procedure, a system is developed in which a car rental agency has a plurality of locations where the agency places the car that are available for the renting. The user can pick up a specifically desired car from any one of the plurality of locations and start driving the car (Japanese Patent No. 2890108).

This system provides an increased number of locations where the user can pick up a car so that the user can rent a specifically desired model of car in a reduced amount of time. However, the user still has to go to one of the locations specified by the car rental agency, and it is not yet as convenient as using one's own car.

### SUMMARY OF THE INVENTION

It is therefore an object of the present invention to provide a car rental system, in which the user can use a rental car as conveniently as using one's own car.

The present invention provides a car rental system including a computer, a network for connecting the computer to terminal units of users, the computer receiving a rental order specifying a model of a rental car and a delivery location for the rental car to be delivered, and a car delivery system for delivering the specified rental car to the specified location.

In accordance with the car rental system of the present invention, the user need not go to the car delivery agency to rent the car the user wishes, and can receive the car at the specified location the user specified. This is convenient for the user, and thus the car rental agency can receive a lot of rental orders.

The above and other objects, features and advantages of the present invention will be more apparent from the following description, referring to the accompanying drawings.

### BRIEF DESCRIPTION OF THE DRAWINGS

FIG. 1 is a conceptual diagram illustrating a network for use with a car rental system according to an embodiment of the present invention;

FIG. 2 is a conceptual diagram illustrating the detail of the integrated management unit shown in FIG. 1; and

FIG. 3 is a conceptual diagram illustrating the procedures in the car rental system of FIG. 1.

### DETAILED DESCRIPTION OF THE PREFERRED EMBODIMENT

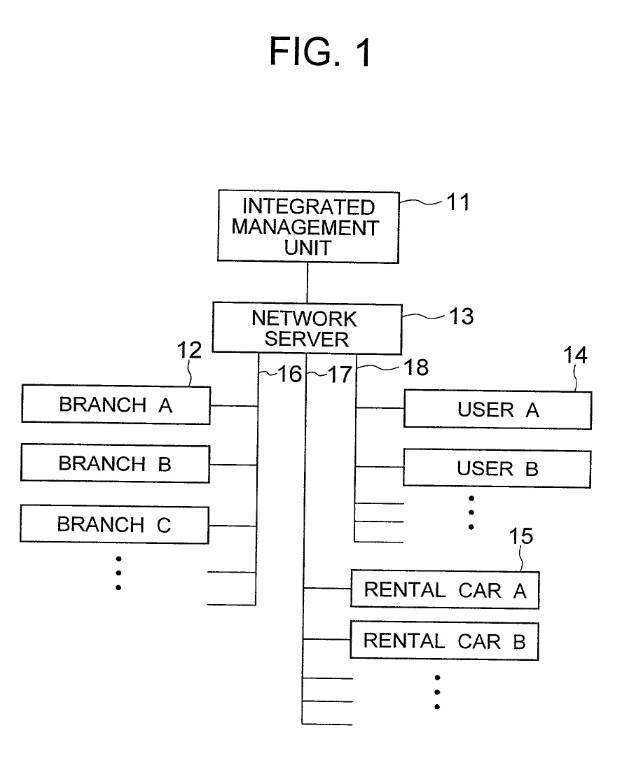

A specific embodiment of a car rental system according to the present invention will now be described with reference to FIG. 1 to FIG. 3. FIG. 1 shows a network for use with a car rental system according to an embodiment of the present invention.

In FIG. 1, the car rental agency has an integrated management unit 11 in association with a network server 13, which is connected to terminal units of branches of the agency 12 through a dedicated network 16, connected to rental cars 15 through a radio communication system 17, and a plurality of terminal units of users 14 through the Internet 18. The integrated management unit 11 is implemented by a computer system or a server. The integrated management unit 11 exchanges information with the branches 12 and instructs the delivery of rental cars based on the request from the users 14. The integrated management unit 11 provides the necessary information to users 14 such as model information, cost information and reservation information.

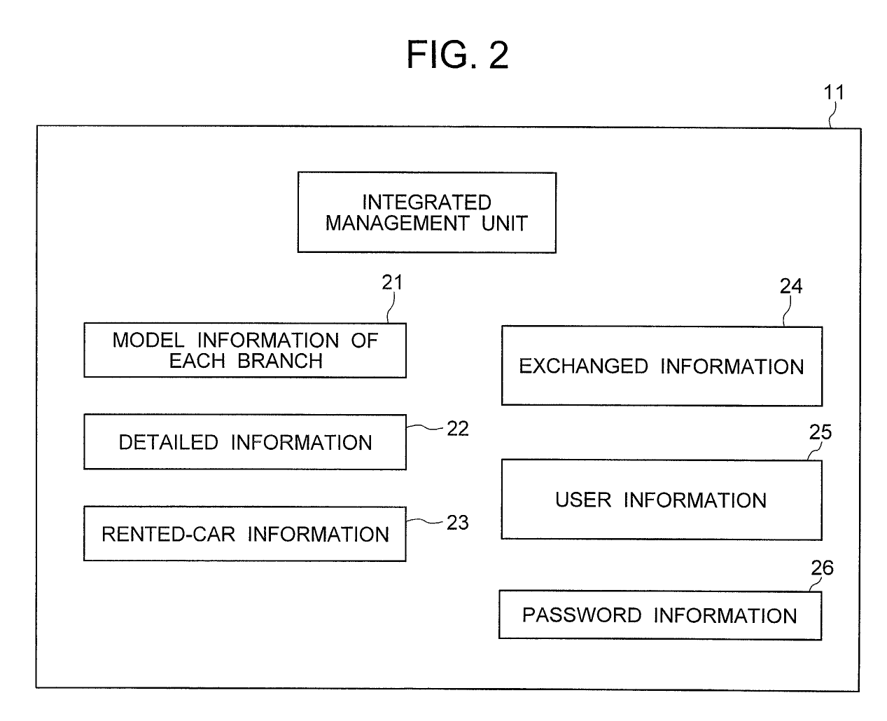

With reference to FIG. 2, the integrated management unit 11 integrally stores therein and manages all the information including model information 21 with respect to models of cars of the fleet of each branch, detailed information 22 with respect to the details of cars available for the rental system, rented-car information 23 with respect to the then-rented car for each branch, information 24 exchanged between the same and other terminal units through the networks, user information 25 with respect to the registered users including identification number of the users and other information, such as telephone numbers of the users, necessary to deliver a car to the user, and password information 26 with respect to management of passwords. The passwords are allocated by the integrated management unit 11 to respective rentals of cars.

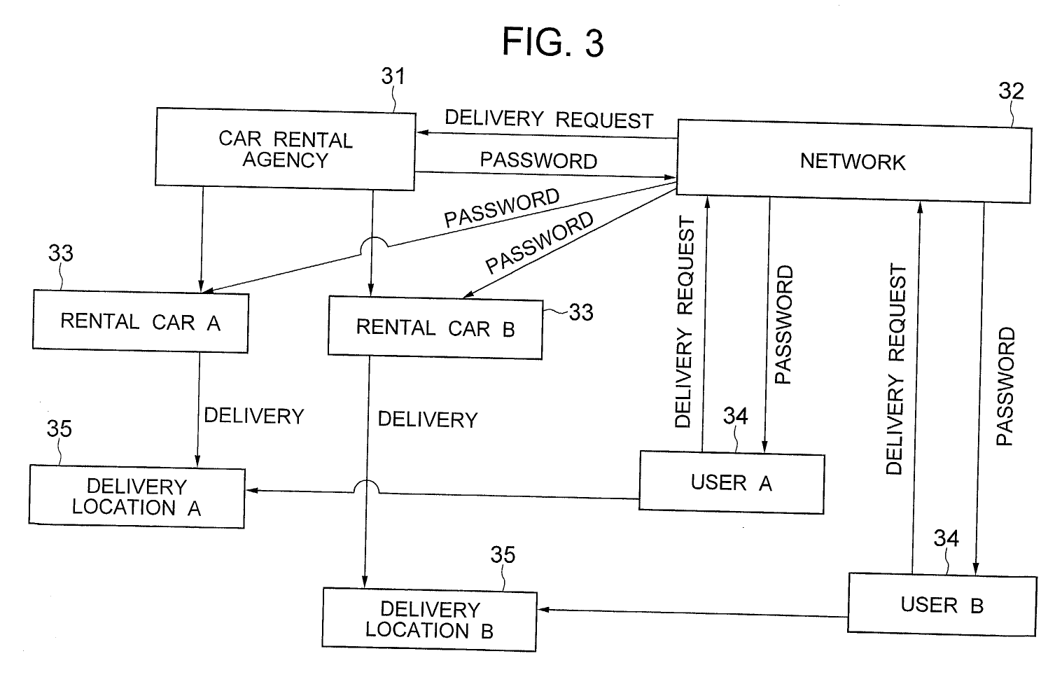

With reference to FIG. 3, an example of the car delivery scheme will be described hereinafter.

Each rental car 33 is equipped with a card slot for receiving a card key and a radio communication system, by which the information in the card slot such as a password is registered/cancelled. The car rental agency 31 monitors the location of each rental car 33 being rented out by using a positioning system generally used for a portable telephone, or the like.

A card key is previously registered for each user 34 and delivered to the each user 34. A door key which is common to some or all of the rental cars may be added to the card key for opening the door. The card key is used for identification of the user 34. The card key may be replaced by any other key, so long as an individual person can be identified, which may be an IC card, a credit card, an identification number, or a finger print.

The user 34 obtains information on the car which the user 34 wishes to rent by accessing the network server of the car rental agency 31 through the own terminal unit connected to the network. Then, the user 34 specifies and enters, through the own terminal unit, the model of car the user 34 wishes to rent and the delivery location to which the user 34 wishes the car to be delivered. The agency 31 sets a password assigned to the use of the rental car to be delivered, and transmits the password, which is required to use the car, to the rental car 33 and to the user 34 through the networks. The network server is connected to the terminal unit of each branch, and operates for processing based on the rented-car information of each branch and the fleet information.

FIG. 3 specifically shows how the car delivery system works when two users specify two different models of cars and two different delivery locations.

A delivery location A or B (35) illustrated in FIG. 3 may be a part of a parking lot of an apartment building, a corporation, or a local community, that has been owned or rented by the car rental agency 31, or may be a parking space in the user's house or the road in front of the user's house that has been specified by the user. Alternatively, the delivery location 35 may be a part of a toll parking lot.

The user A and the user B review the model and cost information on the network 32, and respectively specify, through the network, the models of cars they wish to rent as specified rental cars A and B, and delivery locations A and B to which the users A and B wish the specified rental cars A and B to be delivered. Then, each of the users A and B makes a car delivery request to the car rental agency 31 through the network 32.

Upon receiving the requests, the car rental agency 31 issues passwords respectively to the requests, and transmits the passwords to the specified rental cars A and B, respectively, through the network 32 or radio communication system. The car rental agency 31 also transmits the passwords to the users A and B through network 32 or Internet.

Then, the car rental agency 31 delivers the specified rental cars A and B to the specified delivery locations A and B, respectively, so that the users A and B can start and drive the specified rental cars A and B only by unlocking the cars A and B by using the card keys and the respective passwords. Alternatively, if the password of a specified rental car is set at the password of the card key previously delivered to the user, the user can start the specified rental car simply by using the card key. When delivering the car, the car rental agency 31 selects a branch that is most convenient for the user 34 and sends the user information to the branch. When the specified rental car is not lo available in a near-by branch, the car rental agency 31 instructs another branch to deliver the car.

After a personnel of the car rental agency 31 delivers the car, the personnel or the car rental agency 31 notifies the users A and B of the completion of the delivery, if necessary, and the personnel of the 15 car rental agency 31 can return to the branch without attending the users A and B.

After the specified rental cars A and B are delivered by the car rental agency to the specified delivery locations A and B, respectively, the users A and B, who made the car delivery requests via the network 32, can go to the specified delivery locations A and B to pick up the rental cars A and B, unlock the rental cars A and B by busing the card keys and passwords, and start driving the rental cars A and B, respectively. When the specified delivery location is a parking space in a toll parking lot, the user pays the parking fee and drives the rental 25 car out of the toll parking lot.

Preferably, the users A and B return the cars A and B to the specified delivery locations A and B so that the agency 31 can pick up the returned cars A and B. However, the car can be returned to a location that is different from the specified delivery location. The user can notify the car rental agency of the intention of termination of the rental and the return location by using the Internet, a telephone, etc., either before or after the use of the rental car.

When the car rental agency is notified by the user of the end of the use for the rental car, the car rental agency can automatically cancel the information such as the password of the rental and the identification number of the user in the card slot. This cancel information is transmitted through the radio communication system so as to disable a subsequent operation of the car. The radio communication system can be used for other purposes as follows. When the user reports to the car rental agency that the rental car is stolen, for example, the radio communication system can be used to display a visible sign on the car indicating that it is a stolen car, and to track the location of the car. The radio communication system can be used to cancel the password in the card slot, or to stop the engine of the stolen car, once it comes to a stop, so that the engine cannot be started again.

After notification of the end of the use of the rental car, a computer system installed in the radio communication system can be used to automatically calculate the total charge, and issue an invoice, according to the particulars of the service provided for the user, e.g., the travel distance, the duration of use, the return location, etc.

As described above, the present invention provides a car rental system, in which: the user reviews rental car information on a network, and specifies, through the network, a model of the rental car the user wishes to rent and a delivery location the user wishes the rental car to be delivered; and the car rental agency delivers the specified rental car to the specified delivery location based on the user's input.

With this system, the user specifies a model of rental car and a car delivery location by using information on the network, and the car rental agency delivers the car to the specified location based on the user's input. In this way, the system eliminates the need for the user to go to the agency's location, which is very convenient for the user especially when it is raining. In other words, a specifically desired car is provided at a location that is convenient for the user, and the user does not have to go to the agency's location or a location specified by the agency, whereby the user can use a rental car as if it were the user's own car.

This system is also advantageous for the car rental agency because the system eliminates the need for the agency to provide a space for storing rental cars at or near the agency's location, and it also eliminates the need for attending users at the agency's location, thereby reducing or eliminating the space for attending users or the personnel expenses that would otherwise be required for attending users. Thus, the system of the present invention even enables a non-store business operation.

At the time of the rental order, the user may roughly specify the time of delivery, e.g., by hours, when the specified delivery location is a space of the user's house, a parking space rented to the agency itself, etc., because in such a case, the rental car can be parked there for a relatively long time. However, when the delivery location is a location where it is undesirable to park the rental car for a long time, e.g., the road in front of the user's house, the user can specify the time of delivery by minutes.

While it is most preferred that the delivery location is a parking space in the user's house, rental car users often do not have parking spaces in their houses. Therefore, the delivery location may be the road in front of the user's house, or other locations where the rental car can be parked for a relatively long time, such as a parking space rented to the agency itself, a part of a parking lot of an apartment building, a part of a parking lot of a corporation, and a part of a toll parking lot.

The term “network” as used herein refers to not only the Internet, but also to other networks using a telephone, radio communication system or a facsimile. In any case, the user dose not have to go to the car rental agency's location or a location specified by the car rental agency. Moreover, the car rental agency does not have to attend users, thereby reducing or eliminating the space and/or the cost for attending the users.

Since the above embodiment is described only for an example, the present invention is not limited to the above embodiment and various modifications or alterations can be easily made therefrom by those skilled in the art without departing from the scope of the present invention.

What is claimed is:

1. A car rental system comprising a computer, a network for connecting said computer to terminal units of users, said computer receiving a rental order from a user specifying a model of a rental car and a delivery location for the rental car to be delivered, and a car delivery system for delivering the specified rental car to the specified location.

2. The car rental system as defined in claim 1, wherein said rental order further specifies the delivery time of the rental car, and said car delivery system delivers the specified rental car at the specified delivery time.

3. The car rental system as defined in claim 1, wherein said specified location is either user's house, toll parking lot, parking space of an apartment building, parking space of a corporation or rental parking lot.

4. The car rental system as defined in claim 1, wherein said network includes at least one of Internet, telephone, radio communication system and facsimile.

5. The car rental system as defined in claim 1, wherein key of the rental car is a card key to be inserted in a card slot in the renal car.

6. The car rental system as defined in claim 5, wherein said card key has information specifying identification number of a user and/or a password.

7. The car rental system as defined in claim 6, wherein information in said card slot is registered/cancelled by using a radio communication system.

8. The car rental system as defined in claim 7, wherein said rental order is allocated to a dedicated password.
